(19) United States
(12) Patent Application Publication
(10) Pub. No.: US 2002/0040867 A1
(43) Pub. Date: Apr. 11, 2002

(54) Continuous water cycle water treatment apparatus

(76) Inventor: Wayne Ernest Conrad, Hampton (CA)

Correspondence Address: Philip C. Mendes da Costa, Bereskin & Parr, Box 401, 40 King Street West, Toronto, ON, M5H 3Y2, CA

(21) Appl. No.: 09/970,999

(22) Filed: Oct. 5, 2001

(30) Foreign Application Priority Data
Oct. 6, 2000 (CA) 2.322.991

(51) Int. Cl. B01J 20/00

(52) U.S. Cl. 210/97; 210/198.1; 210/205

(57) ABSTRACT

A household apparatus for the purification of water contaminated by microorganisms and chemicals is taught.

### FIELD OF THE INVENTION

This invention relates of an apparatus for the production of water fit for human consumption from water contaminated by microorganisms, chemicals, heavy metals and minerals.

### BACKGROUND OF THE INVENTION

The production of water fit for human consumption from water contaminated by micro-organisms, chemicals, heavy metals and minerals is a requirement throughout the world. Many different proposals have been made for the purification of contaminated water.

The most popular system in widespread domestic (household) use for the purification of contaminated water is a pitcher wherein contaminated water is passed through a filter made of a combination of a porous media filter, activated carbon, and an ion exchange resin and into a clean water reservoir within the pitcher. This type of system will reduce the levels of chlorine, lead, and pesticides. However, there are several disadvantages associated with this device. The first disadvantage of this water purification system is that the structure of the filter provides a breeding ground for microorganisms thereby multiplying the dangers of microorganisms, which may be present in very low numbers. Another disadvantage of such a water purification system is that the filter life is not measured and it is possible for the user to employ the filter beyond its useful life. A further disadvantage of such a water purification system is that oils and fuels often present in water drawn from lakes and rivers are not readily removed and that these oils and fuels tend to coat the filters and damage their operational life and effectiveness. Other filters incorporate an iodine product to minimize the risk of microbiological hazards, however, these materials often impart undesirable tastes and many are potential carcinogens.

Another popular system in use for the purification of contaminated water is a system, which employs an ultraviolet light for disinfection in series with a porous media and carbon filter. This type of system will reduce the levels of chlorine, lead, and pesticides and has some disinfection capability. However, there are several disadvantages associated with this device. A disadvantage of this water purification system is that the ultraviolet light's disinfection efficacy is greatly diminished by turbidity or color in the water which can cause the filter to become contaminated by microorganisms which can readily live and breed therein thereby multiplying the danger from any microorganisms which may be present.

### SUMMARY OF THE INVENTION

In accordance with the instant invention, a reliable domestic water treatment apparatus is provided which employs multi-pass filtration during ozonation for the treatment of drinking water and waste water for a household.

The water treatment apparatus may be a counter top unit (i.e. it may be designed to sit on a counter in a kitchen or the like) to provide water as required to a user, an under counter unit (i.e. it may be designed to be mounted under a counter near a sink in a kitchen or the like) to treat all or part of the water which is delivered to the sink, or a whole house unit (i.e. it may be positioned immediately downstream of the water inlet to a house to treat all of the water which is supplied for use in the house). A counter top water treatment apparatus preferably is free standing (i.e. it is not connected to the counter or the household plumbing). Such units are filled manually when treated water is required. However, such units may be connected to the household water supply. An under counter unit and a whole house unit are connected to the plumbing system in the house.

The water treatment cycles use continuous filtration to treat the water as the water is ozonated. Accordingly, physical filtration is used to removed contaminants at the same time that ozonation is used to treat the water. This produces a synergism that results in a substantial acceleration of the time required to treat an aliquot of water.

In one aspect, water passes through a filter until the ozone contact chamber is full. The filtration continues while the water is ozonated. The contact chamber may be in the form of a treatment chamber (e.g. a tank or carafe) or a flow reactor (e.g. a longitudinally extending contact chamber).

According to another aspect, a counter top water treatment apparatus uses multipass filtration during ozonation and a check valve is used to control the dispense cycle. A pressure switch is preferably used to monitor the life of the filter.

According to another aspect, a counter top water treatment apparatus uses multipass filtration during ozonation and the unreacted ozone is used to treat the prefilter during the treatment cycle.

According to another aspect, a counter top water treatment apparatus has a carafe that is movable to dispense water by pouring the water out from a dispense tube. The carafe has a float valve to close the off gas exit port/ prefilter water inlet when water is dispensed to prevent water from exiting through the prefilter. A ball valve is preferably used to seal the dispense port during treatment.

According to another aspect, an under counter or whole house water treatment apparatus uses multipass filtration during ozonation and has a reservoir to store treated water. A degassification cycle is used, such as passing the treated water through a gas/water separator, to remove ozone entrained in the water prior to the water being dispensed to the reservoir. A solenoid valve isolates the treatment chamber from the ozone source during the degassification process.

In accordance with another aspect of the instant invention, a water treatment apparatus comprising:

(a) a water treatment reactor which contains a volume of water to be treated, the water treatment reactor comprises a water conduit having an inlet end and an outlet end and the inlet and outlet ends are in flow communication during a water treatment cycle so as to define a water flow path;

(b) a treatment filter positioned in the water flow path;

(c) a pump positioned to cause the water to flow through the water flow path during the treatment cycle; and,

(d) an ozone source in flow communication with at least one of the water flow path whereby ozone is introduced into the apparatus during a treatment cycle.

In one embodiment, the volume of water is preferably passed through treatment filter from one to ten times during a treatment cycle, more preferably from two to eight times during a treatment cycle and most preferably from four to six times during a treatment cycle.

In another embodiment, the water flow path comprises the water conduit and a water storage chamber and the inlet end and the outlet end of the water conduit are each in flow communication with the water storage chamber. Preferably, the water storage chamber is removably mounted on the apparatus.

In another embodiment, the ozone source comprises an ozone generator in flow communication with the water storage chamber whereby the water storage chamber also functions as a water treatment chamber.

In another embodiment, the ozone source comprises an ozone generator in flow communication with the water conduit.

In another embodiment, the water flow path comprises the water conduit and a water storage chamber and the inlet end and the outlet end of the water conduit are each in flow communication with the water storage chamber and the ozone generator is in flow communication with the water conduit at a position downstream from the treatment filter and upstream from the water storage chamber.

In another embodiment, the apparatus further comprises a treated water outlet and a gas/liquid separator positioned upstream from treated water outlet.

In another embodiment, the apparatus further comprises a pretreatment filter and an off gas collector in communication with water being treated, the off gas including ozone, and a conduit connecting the off gas collector and the pretreatment filter in flow communication during at least a portion of the treatment cycle.

In another embodiment, the apparatus further comprises a pressure actuated valve positioned for selectively connecting a dispense conduit in flow communication with the water conduit and a flow prevention valve positioned downstream from the dispense conduit.

In another embodiment, the water storage chamber has a water inlet port and an associated water inlet valve and the apparatus includes a sensor for monitoring the water level and for closing the water inlet valve when the water storage container contains sufficient water for the treatment cycle. Preferably, the sensor comprises a float switch. The sensor may also monitor the water level when water is removed from the water storage chamber and opens the water inlet valve to allow the water storage chamber to be refilled. Preferably, the sensor comprises two float switches.

In another embodiment, the apparatus further comprises a treated water passage and a routing valve for selectively directing water to at least one of the water conduit and the treated water passage. During a dispense mode, the pump is preferably energized and the routing valve connects the water conduit and the treated water passage whereby the pump is used to dispense treated water.

In another embodiment, the inlet and outlet end of the water conduit are in direct flow communication to define a continuous flow reactor. Preferably, the water treatment conduit has a residence time of 30 to 120 seconds.

In another embodiment, the apparatus further comprises a water inlet which is positioned upstream of the treatment filter. Preferably, the water inlet is positioned downstream from the ozone source such that water to be treated is filtered prior to ozonation.

In another embodiment, the water storage chamber further comprises a water inlet and a mechanical valve for automatically closing the water inlet during the treatment cycle.

In another embodiment, the water storage chamber further comprises a water outlet and a mechanical valve for automatically closing the water outlet during the treatment cycle and automatically opening the water outlet when water is poured out of the water outlet of the storage chamber.

In another embodiment, the apparatus comprises a household water treatment apparatus and the water treatment reactor is in flow communication with a pressurized source of water which is provided to a home, the apparatus includes a reservoir which is selectively connectable to the water treatment reactor and a water supply conduit to the home, the water reservoir includes a sensor which sends a signal to a controller when additional treated water is required in the reservoir. Preferably, the sensor comprises a pressure sensor.

### BRIEF DESCRIPTION OF THE DRAWINGS

A further, detailed description of the invention, briefly described above, will follow by reference to the following drawings of preferred embodiments of the invention in which:

FIG. 1 is a schematic view of the first embodiment of a water treatment apparatus according to the instant invention which may be used as an under counter or whole house treatment unit;

FIG. 2 is a schematic drawing of the second embodiment according to the instant invention which may be used as an under counter or whole house treatment unit;

FIG. 3 is a schematic drawing of a third embodiment according to the instant invention which may be used as an under counter or whole house treatment unit;

FIG. 4 is a perspective view of a counter top water treatment apparatus;

FIG. 5 is a top plan view of a counter top water treatment apparatus of Figure;

FIG. 6 is a top plan view of the water treatment apparatus of FIG. 4 wherein the water treatment carafe has been removed,

FIG. 7 is a schematic drawing of a fourth embodiment according to the instant invention which may be used as an under counter or whole house treatment unit;

FIG. 8 is a schematic drawing of a flow circuit for the counter top water treatment apparatus shown in FIGS. 4-6;

FIG. 9 is a schematic drawing of a an alternate embodiment of a counter top water treatment unit according to the instant invention; and,

FIG. 10 is an alternate embodiment of an under counter or whole house treatment unit according to the instant invention.

### DETAILED DESCRIPTION OF THE INVENTION

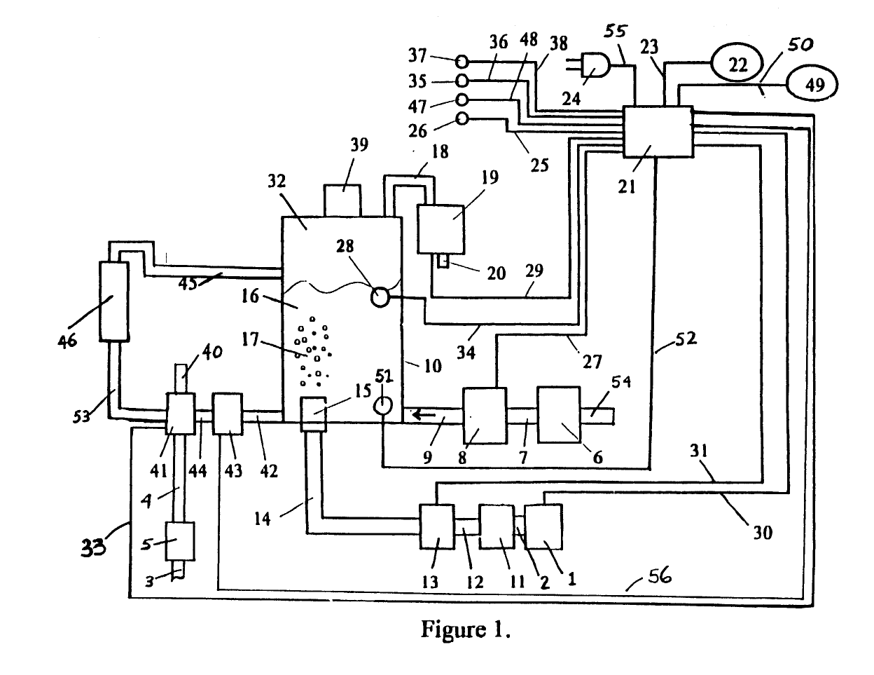

As shown in FIG. 1, a water treatment apparatus comprises a treatment chamber or carafe 10, a filter 46 and a micro-controller 21. The operational elements of the water treatment apparatus may be provided in any shaped housing which is desired.

Water is provided to treatment chamber via water inlet 54. Water inlet 54 may be provided with water from any particular source such as municipal water, well water or the like so as to be connectable in flow communication with a source of pressurized water. Accordingly, water inlet 54 is preferably used as an under counter or whole house treatment unit. An optional water pump may be provided, if needed, to feed water into treatment chamber 10.

The water is fed optionally through an initial pre-filter (such as screen 6) to remove coarse particulate matter, which may be present in the water intake. The water passes through tube 7 to a valve, such as solenoid valve 8. The operation of solenoid valve 8 is controlled by micro controller 21 via wire 27. When the solenoid valve is opened, water passes via tube 9 into treatment chamber 10 due to the pressure of the water feed. When water treatment chamber 10 contains a sufficient amount of water, micro controller 21 sends a signal to valve 8 closing valve 8 and isolating chamber 10 from water inlet 54. The water level in treatment chamber 10 may be measured by any means known in the art. As shown in FIG. 1, upper float switch 28 is provided. When the water reaches a pre-determined level, float switch 28 sends a signal via wire 34 to micro controller 21 which then sends a signal via wire 27 to valve 8 closing valve 8.

As shown in FIG. 1, treatment chamber 10 has a head space 32. It will be appreciated by those skilled in the art that treatment chamber 10 need not have a substantial head space as shown in FIG. 1 and, it need not have essentially any head space. Head space 32 is provided to allow off gas from the treatment of the water to accumulate prior to exiting treatment chamber 10. If sufficient head space is not provided, alternate means is preferably provided to enable off gas to be separated from the water so that water does not exit treatment chamber 10. For example, a water/liquid separator may be provided at the exit to vessel 10 for this purpose.

Once valve 8 has been closed, treatment of the water 16 in chamber 10 may be commenced immediately. Alternately, the treatment may be delayed until start button 22 is pressed to send a signal via wire 23 to micro controller 21. Once the treatment cycle is commenced, micro controller 21 sends a signal via wire 30 to air pump 1, wire 31 to ozone generator 13 and wire 56 to water pump 43. When air pump 1 is actuated, it causes air to pass through tube 2 into air dryer 11 and then through tube 12 into ozone generator 13. In ozone generator 13, at least a portion of the oxygen in the air passing through tube 12 is converted to ozone. The ozone enriched gas is fed by tube 14 to sparger 15 that is provided in treatment chamber 10. Sparger 15 may be of any type known in the art. The ozone enriched air exists sparger 15 as bubbles 17. Bubbles 17 pass through water 16 to head space 32. During its passage through water 16, portion of the ozone reacts with contaminants in water 16.

Pump 43 draws water that is being treated, preferably together with ozone, through tube 42 and through tube 44 to valve 41. As shown in FIG. 1, valve 41 is a three way valve to selectively connect tube 44 with water outlet 40, clean water outlet 3 or tube 53. It will be appreciated that two or three individual valves may be used in place of a single three way valve.

During the treatment cycle, valve 41 selectively connects tube 44 with tube 53. Accordingly, water pump 43 causes water to circulate through tube 53, through filter 46, through tube 45 back into treatment chamber 10. Accordingly, during treatment, water is continuously circulated through filter 46.

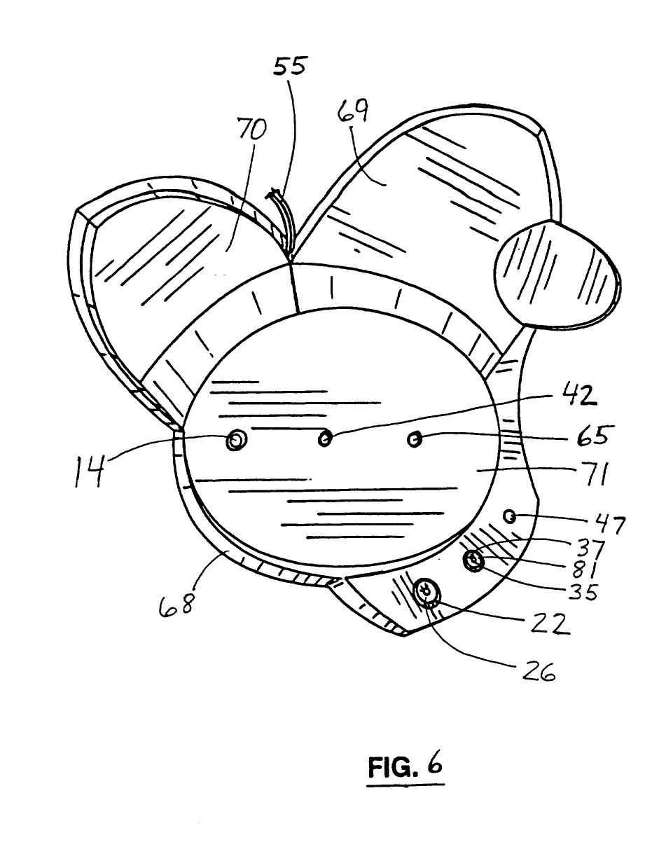

Filter 46 is preferably a carbon block filter but may be a granular carbon water filter. Further, filter 46 may have other additives that are known in the filter art. It will further be appreciated that water out take tube 42 and water return tube 45 may be provided at any location in treatment vessel 10. Preferably, water outtake tube 42 is provided in the bottom of vessel 10, such as is shown in the embodiment of FIG. 6, to remove any sediment buildup that may occur in water treatment chamber 10.

The treatment cycle is designed such that, in a single treatment cycle, water 16 will pass at least twice and preferably several times through filter 46. Preferably, the volume of water in treatment chamber 10 will pass through filter 46 from one to ten times, preferably two to eight times, and, most preferably form four to six times. The multiple passes of the water through filter 46 helps to ensure that all parts of water 16 pass at least a few times through filter 46. Preferably, the treatment time varies from one to twenty minutes, more preferably from two to fourteen minutes and, most preferable from four to six minutes. The continual circulation of water through filter 46 causes filterable material to be removed from the water and deposited in filter 46. Accordingly, during the life of filter 46, the flow rate of material through filter 46 will be reduced. For example, when filter 46 is new, water may circulate at a rate of two volumes of container 10 through filter 46 per minute and, at the end of the life of filter 46, water may circulate at a rate of a halve volume of water in treatment chamber 10 through filter 46 per minute.

Advantageously, by continuously circulating water through filter 46, filter 46 assists the ozonation of the water by removing from the water contaminants that may otherwise react with ozone. The kinetic rate of the reaction of ozone with organics and inorganics is substantially faster than the kinetic rate of reaction of ozone with microorganisms. Accordingly, if organics and inorganic material is present in the water together with microorganisms, the reaction kinetics favors the reaction of the ozone with the organics and inorganic material. This dramatically reduces the disinfection efficiency of the ozone until the organic and inorganic material have essentially been removed from the system. Therefore, by continually circulating water through filter 46, a substantial portion of the organic and inorganic material may be removed from the water during the initial portion of the treatment cycle resulting in altering the reaction kinetics to favor the reaction of ozone with microorganisms.

As the purpose of filter 46 is to remove organic and inorganic material, it will be appreciated that filter 46 need not have pores that are submicron in size. Filter 46 may have a pore size from 0.5 to 30 microns, preferably from 1 to 10 microns and, more preferably from 1 to 5 microns. At such a lower pore size limit, some microorganisms will pass through filter 46 to be treated by the ozone. However, due to the lower pore size limit, the water will still be able to flow through filter 46 at an appreciable rate compared to the volume of water to be treated in a single cycle without applying significant pressure via pump 43. Preferably, filter 46 includes carbon and more preferably is a carbon block filter.

Ozone which is not converted to oxygen as it travels through the water being treated accumulates in head space 32. In the embodiment of FIG. 1, a portion of the off gas is fed via passage 18 to ozone sensor 19 and subsequently to ozone destructor 20. Ozone sensor 19 may be any ozone sensor known in the art. Preferably, ozone sensor 19 comprises an ozone destructor catalyst such as CARULITE. The contact between ozone and the CARULITE (which is a mixture of iron, manganese, and tin oxide) produces an electrical response which is proportional to the concentration of ozone in the off gas. Accordingly, ozone sensor produces a signal which is transmitted via wire 29 to micro-controller 21. Micro-controller 21 monitors the signal from ozone sensor 19 and terminates the treatment cycle when a predetermined signal has been received. For example, micro-controller 21 may be pre-programmed to terminate the treatment cycle when a signal of a particular strength is received from ozone sensor 19. Alternately, micro-controller 21 may monitor the signal received from ozone sensor 19 and terminate the treatment cycle when a sufficient amount of ozone has passed through ozone sensor 19. Alternately, or in addition, micro-controller 21 may include a timer which will terminate the treatment cycle if a predetermined level of ozone is sensed by ozone sensor 19 for a predetermined time. Alternately, or in addition, micro-controller 21 may include a timer which will terminate the treatment cycle after time once a predetermined level of ozone is sensed by ozone sensor 19. It will be appreciated that any ozone sensor known in the art may be utilized. For example, a redox sensor may be provided to monitor the potential of the water in treatment chamber 10.

If micro-controller 21 receives a signal indicating that the level of treatment of the water in treatment chamber 10 was insufficient to achieve a predetermined level of disinfection, micro-controller 21 may terminate power to air pump 1 and ozone generator 13. Micro-controller 21 may also send a signal to valve 41 via wire 33 connecting tube 44 in flow communication with water outlet 40. Water outlet 40 may be connected to a drain in the house or the like so that the water in the system (i.e. treatment chamber 10 and tubes 42, 44, 53, 45 and filter 46) is rejected to waste. At the same time, micro-controller 21 may actuate light 37 via wire 38 to advise a user that the water was not sufficiently treated. When the water has been drained from the system, lower float switch 51 sends a signal via wire 52 to controller 21 which de-energizes water pump 43. In an alternate embodiment, it will be appreciated that micro-controller 21 may be programmed to cause the water to be cycled through one or more consecutive treatment cycles to see if the desired level of treatment is achieved in a subsequent cycle prior to rejecting the water via valve 41 and outlet 40 to waste.

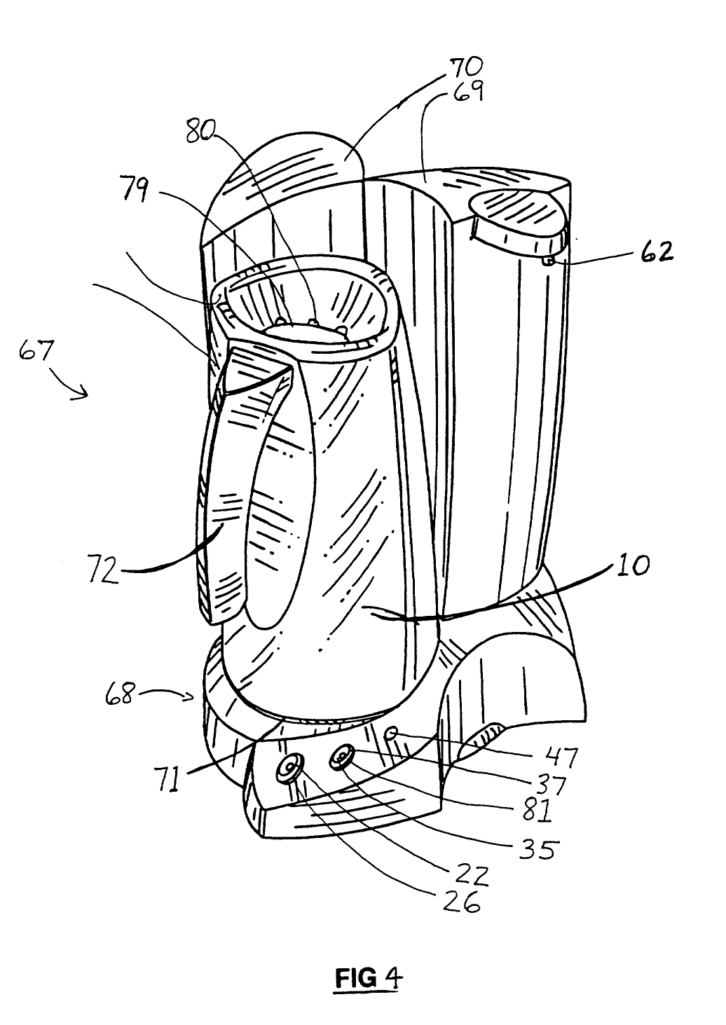

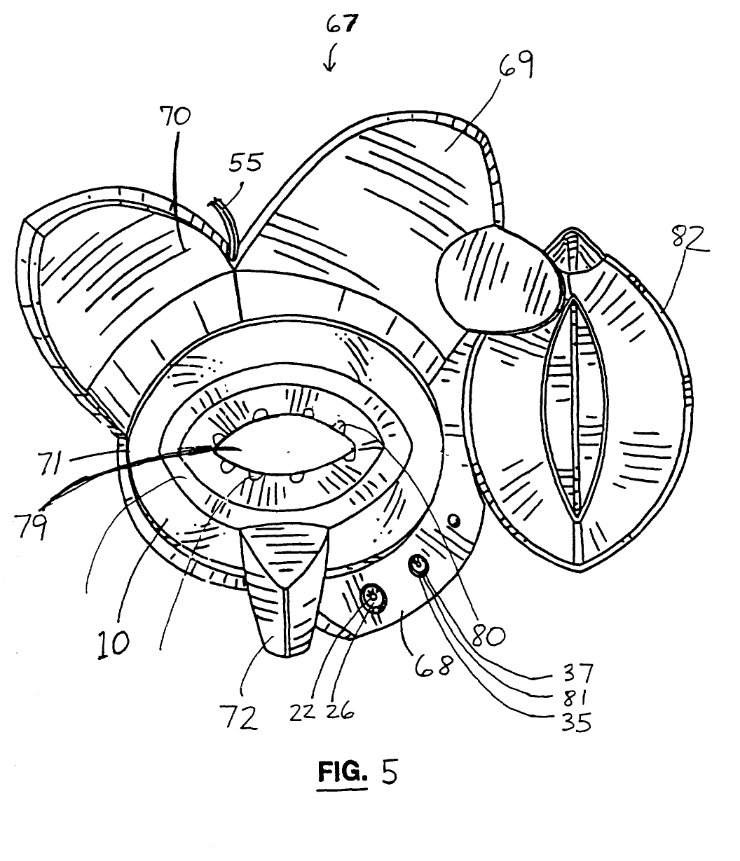

If micro-controller 21 determines that a sufficient level of treatment has been achieved, then pump 43 may be de-energized and the water maintained in the system until it is required. Alternately, micro-controller 21 may actuate valve 41 connecting tube 44 in flow communication with tube 4. Pump 43 will cause water to flow from tube 4 through optional post filter 5 and through clean water outlet 3. Clean water outlet 3 may be the inlet to a storage tank which is provided as part of a system, the water supply to a sink in a house (if the water treatment apparatus is sized to be positioned adjacent a sink in a house) or to the main water supply to a house (e.g. immediately downstream from the main water inlet to a house) or it may provide water on demand such as a water dispenser 62 to a clean water carafe as shown in FIGS. 4 and 5.

Treatment chamber 10 is provided with off-gas destructor (e.g. CARULITE, carbon or the like) 39 which is in communication with the ambient. Accordingly, only a portion of the off gas passes through passage 18, ozone sensor 19 and subsequently destructor 20 (which converts any remaining ozone in the gas passing through ozone sensor 19 to oxygen). It will be appreciated that all of the off gas may be passed through passage 18. Further, it will be appreciated that if a redox sensor is provided in the water in treatment chamber 10, passage 18 and ozone sensor 19 are not required and accordingly all of the off gas may pass through ozone destructor 39.

Micro-controller 21 is provided with power via plug 24 and wire 55. Plug 54 may also provide power to air pump 1, ozone generator 13 and water pump 43. Further, the water treatment apparatus may include light 26 which is connected to micro-controller 21 via wire 25. Light 26 is a power on light to indicate that the apparatus has power and is turned on.

Preferable, the apparatus includes a light 35 which is connected to micro controller 21 via wire 36. Light 35 will provide a first indicator to a user indicating that the water treatment cycle is proceeding (e.g. light 35 may flash). When water is being dispensed and/or when the treatment cycle is completed and water has not yet been dispensed, then light 35 may provide a second signal to a consumer (e.g. light 35 may remain on) indicating that the water treatment cycle has been successfully completed.

When the water has been removed from chamber 10, lower float switch 51 sends a signal via wire 52 to controller 21 which deenergizes water pump 43. At the same time, micro-controller 21 may open valve 8 allowing additional water to be treated to be fed to treatment chamber 10. Once treatment chamber 10 is full, the treatment cycle may be automatically recommenced.

It will be appreciated by those skilled in the art that start button 22 may be provided to actuate valve 8 so as to fill chamber 10 only when it is desired to treat water. Alternately, valve 8 may automatically be opened by micro-controller 21 whenever lower float switch 51 indicates that chamber 10 is empty. Button 22 may then be used to actuate a treatment cycle only when water is required.

Once a predetermined number of water treatment cycles have occurred, micro-controller 21 may supply power to light 47 by means of wire 48 to indicate that filter 46 must be replaced. It will be appreciated that micro-controller 21 may cause light 47 to provide a first signal (e.g. to flash intermittently) to indicate that the end of the filter life is approaching after a first preset number of cycles. After a second preset number of cycles, light 47 may provide a second signal to a user (e.g. it may provide a solid light) indicating that the filter life has ended.

Micro-controller 21 may be programmed to prevent further water treatment to occur until filter 46 has been replaced. To this end, the housing in which filter 46 is provided may have a reset button which is automatically actuated when filter 46 is replaced. Alternately, reset button 49 which is connected to micro-controller 21 via wire 50 may be provided so that a user may manually press reset button 49 once filter 46 has been replaced.

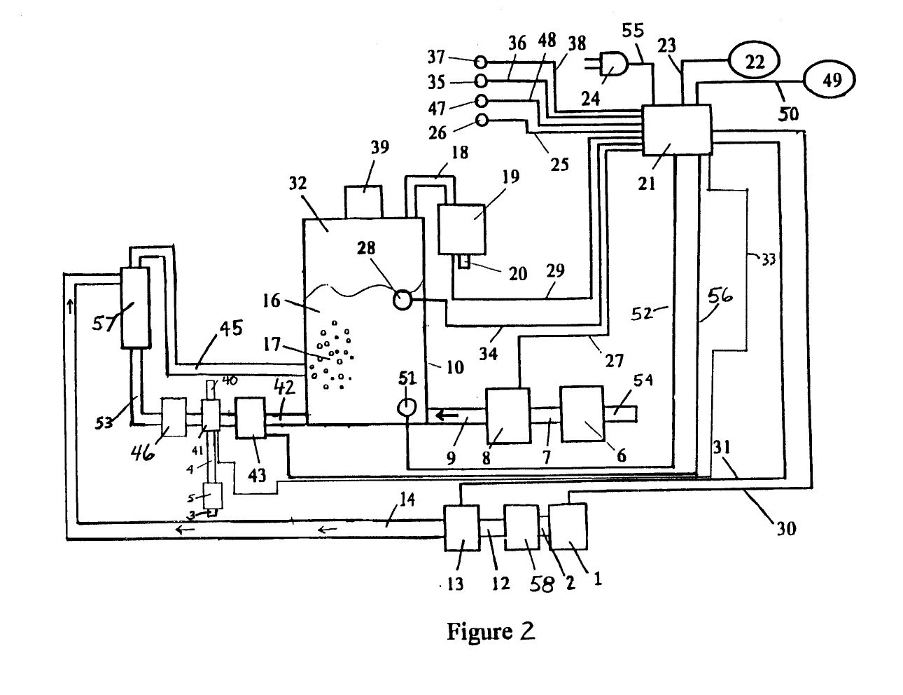

The alternate embodiment shown in FIG. 2 utilizes venturi 57 in place of sparger 15. In this embodiment, ozone enriched air travels through tube 14 to venturi 57 where it is introduced to the water being treated passing through tube 53. Venturi 57 is positioned downstream from filter 46 so that the ozone bubbles which are introduced into the water are not removed by filter 46. In an alternate embodiment, treatment chamber 10 may be replaced by a tubular contact reactor (a flow reactor) which may essentially comprise a continuous tube having a length sufficient to provide a predetermined residence time of, for example, from 30 to 120 seconds, preferably from 45 to 190 seconds and, most preferably from 60 to 75 seconds.

In the embodiment of FIG. 2, air dryer 11 has been replaced by oxygen concentrator 58 so as to provide oxygen enriched air to ozone generator 13. In a further embodiment, it will be appreciated that an air dryer may be provided in series with oxygen concentrator 58.

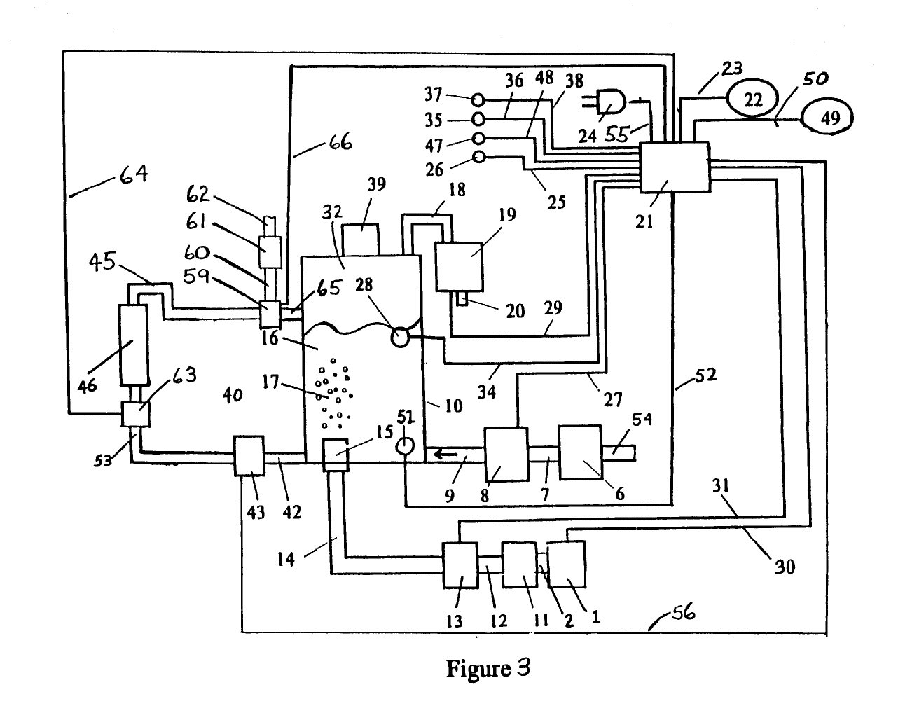

The embodiment of FIG. 3 utilizes sparger 15 to introduce ozone into water treatment chamber 10. In the embodiment of FIG. 3, valve 59 has been included downstream from filter 46. Valve 59, which may be a solenoid valve, selectively connects water flow passage 45 with passage 65 which is flow communication with treatment chamber 10 or passage 60. Accordingly, at the end of the treatment cycle, micro-controller 21 may de-energize air pump 1 and ozone generator 13. At the same time, or subsequently, micro-controller 21 may send a signal via wire 66 to valve 59 connecting passage 60 in flow communication with passage 45. Accordingly, water pump 43 will cause treated water to pass through filter 46, through passage 45 and into passage 60. Passage 60 is in flow communication with dispenser 62. A post filter or polishing filter 61 may be provided upstream of dispenser 62. Polishing filter 61 removes any remaining impurities or oxidized contaminants which remain in the system.

In FIG. 3, pressure sensor 63 is also provided upstream from filter 46 in water flow passage 53. Pressure sensor 63 senses the pressure in the water line upstream from filter 46. As filter 46 is used, the back pressure caused by filter 46 will increase. As the back pressure increases, the rate of water flow through filter 46, and accordingly, water passage way 53 will decrease. Micro-controller 21 receives the signal from pressure sensor 63 via wire 64. Pressure sensor 63 may be used to warn a user that the filter life is about to expire or has expired via warning light 47. Accordingly, pressure sensor 63 may replace, or in addition to, the treatment cycle counter in micro-controller 21. In addition, when a pre-set pressure is reached in passage way 53, a signal sent to via wire 64 to micro-controller 21 may be utilized to shut down the water treatment apparatus until the filter is replaced and the micro-controller is reset.

Alternately, a flow sensor may be used in place of pressure sensor 63. As the rate of flow through passage way 53 is proportional to the life of filter 46, a flow sensor may be used to provide a signal via wire 64 to micro-controller 21 to indicate that filter 46 is approaching the end of its life or that the life of filter 46 has expired. Typically, filters are rated by the amount of water which they may treat. Accordingly, by using a flow sensor, the life of filter 46 may be more accurately measured based upon the actual amount of water which passes through filter 46.

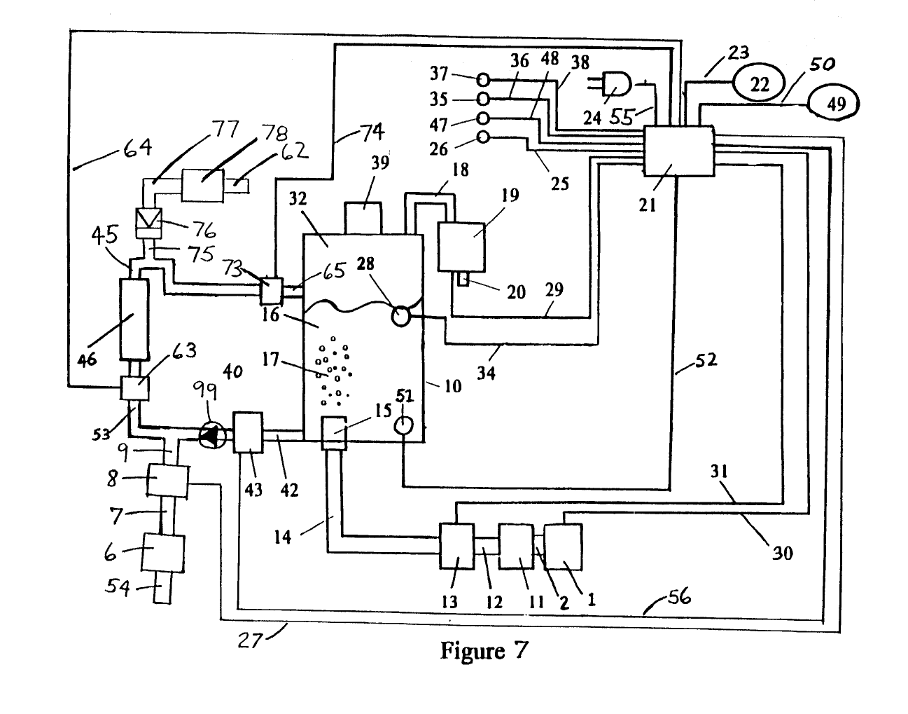

FIG. 7 shows an alternate embodiment of the flow circuit shown in FIG. 3. In the embodiment of FIG. 7, water inlet 54 is in fluid communication with the continuous water treatment loop at a position upstream from filter 46 and downstream from the point at which ozone is introduced into the water to be treated. In this way, the water is initially filtered by filter 46 prior to ozone 17 being introduced into the water. Check valve 99 is provided downstream from pump 43 and upstream from water inlet tube 9. Check valve 99 prevents high pressure water entering via tube 9 from traveling rearwardly to pump 43.

In the embodiment of FIG. 7, an alternate dispense system is utilized. Pursuant to this embodiment, spring loaded check valve 76 is positioned downstream from water tube 75. Valve 73 is an open/closed valve, such as a solenoid valve which is controlled by micro controller via wire 74. When solenoid valve 73 is open, spring loaded check valve 76 will isolate water tube 75 from water passage 77 and the water will circulate through a continuous loop back into treatment chamber 10. When solenoid valve 73 is closed (e.g. at the end of a successful treatment cycle), water pump 43 will cause pressure to build up in water tube 75 until the pressure exceeds that of spring loaded check valve 76 and opens check valve 76. At this point, pump 43 will cause water to be dispensed through water tube 77, through optional polishing filter 78 and out through dispenser tube 62.

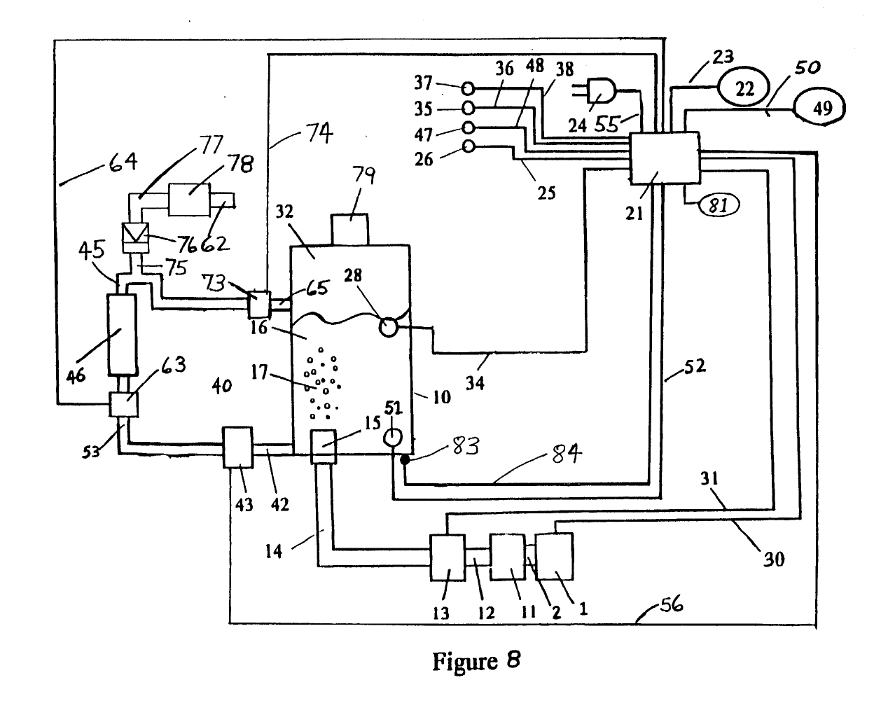

FIG. 8 is a schematic diagram of a counter top water purifier. Accordingly, water is provided to treatment chamber 10 via pre-filter 79 (such as being poured therethrough). Pre-filter 79 may be granulated carbon which is removably held in position on the top of treatment chamber 10 by securing tabs 80 (see FIGS. 4 and 5). In this embodiment, off gas from head space 32 is evacuated from treatment chamber 10 via pre-filter 79. Accordingly, pre-filter 79 also functions as an ozone destructor. At the end of a treatment cycle, water may be automatically dispensed from treatment chamber 10 by closing open/closed valve 73 causing pressure to build up in tube 75 due to the continued operation of water pump 43. Accordingly, water will be dispensed via tube 77 through optional polishing filter 78 and out dispenser tube 62 into, e.g., clean water carafe 82 (see FIG. 5).

A counter top water treatment apparatus according to the embodiment of FIG. 8 is designated by reference numeral 67 in FIGS. 4-6. Water treatment apparatus 67 comprises base portion 68 comprising filter housing 69, electronics housing 70 and platform 71 for removably receiving treatment chamber 10. Treatment chamber 10 is preferably provided with a handle 72 for use in manipulating treatment chamber 10.

When treatment chamber 10 is positioned on platform 71, sparger 15 is aligned with water inflow passage 14. In addition, water outflow tube 42 and water inflow tube 65 are connected in fluid communication with treatment chamber 10. As shown in FIG. 5, a clean water carafe 82 may be removably positioned underneath dispense tube 62 for receiving treated water from water treatment apparatus 67. When dispense button is depressed, water is dispensed to clean water carafe 82.

As shown in FIG. 8, a microswitch 83 may be provided on base housing 68 (e.g. beneath platform 71) to sense when the carafe is present and to send a signal to micro controller 21 via wire 84. In this way, micro controller 21 may prevent a water treatment cycle from being initiated if start button 22 is accidentally depressed when treatment chamber 10 is removed from platform 71.

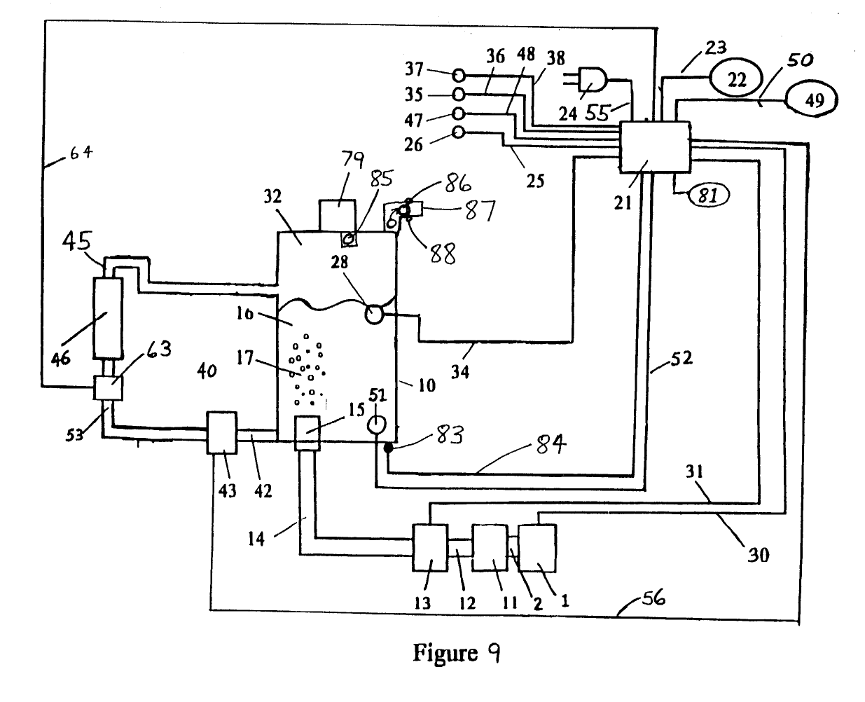

In FIG. 9, treatment chamber 10 is removably mounted in the water treatment apparatus, such as is shown in FIGS. 4-6. In this embodiment, water pump 43 is not used to pump treated water from the water treatment apparatus to a clean water carafe or the like. Instead, water treatment apparatus is provided with a dispense tube 87 to allow water to be poured out from water treatment carafe 10. Dispense tube 87 is provided with ball 86 which is movably mounted in dispense tube 87 between the first position (adjacent the top of treatment chamber 10) to prevent off gas from passing out through dispense tube 87 during a treatment cycle and a second position (the dispense position). When water is to be dispensed, ball 86 moves to the second position where it is distal to treatment chamber 10 (e.g. when carafe 10 is inclined to pour out water from the carafe). In this second position, water travels through dispense tube 87 and bypasses ball 86 by means of dispense tube ports 88.

Ball valve 85 is preferably provided in flow communication with prefilter 79 to isolate prefilter 79 from the interior of water treatment chamber 10 when water is being dispensed from treatment chamber 10 via dispense tube 87. Accordingly, when treatment chamber 10 is to be filled, water is poured through prefilter 79, past ball valve 85 into treatment chamber 10. When water is to be dispensed, treatment chamber is inclined to pour out water and the ball in ball valve 85 moves upwardly to seal the port to prefilter 79.

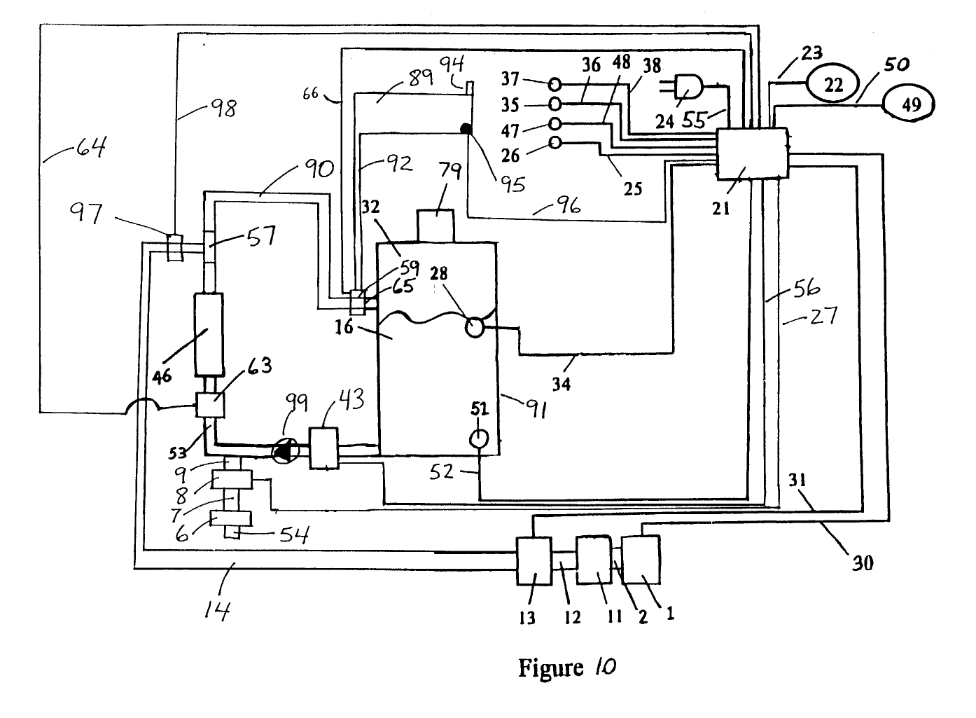

FIG. 10 shows a schematic drawing of a whole house water treatment or an under counter water treatment unit. Pursuant to this embodiment, a single water pump 43 is utilized to control the low of the water through the unit.

In the embodiment of FIG. 10, micro-controller 21 includes a timer to control the operation of a treatment cycle. It will be appreciated that the water treatment apparatus may be provided with an ozone sensor or redox sensor for controlling the treatment of a process in a similar manner to the embodiments discussed previously. Ozone enriched gas conduit 14 is provided with a solenoid valve 97 which is actuated by controller 21 between an open and a closed position by means of a wire 98. When valve 97 is in the open position and water pump is in operation, venturi 57 draws ozone containing gas into extended contact reactor 57. When valve 97 is closed, extended contact reactor is isolated from the ozone generator.

At the end of a successful treatment cycle and when water is required in reservoir 89, micro controller 21 closes valve 97 by means of wire 98. This isolates passage 14 from the continuous water loop. Water pump 43 is operated to cause the water which has been treated to flow once through gas liquid separator 91 to remove ozone bubbles from the treated water. At the end of this degassification cycle, valve 59 is actuated to connect passage way 92 in flow communication with extended contact chamber 90. Water is fed via passage way 92 into reservoir 89.

When all the water has been pumped into reservoir 89 via water pump 83, lower float switch 51 drops and sends a signal via wire 52 to micro controller 21. Micro controller 21 opens valve 8 so that pressurized water (e.g. from a municipal water supply or well water) may be fed to the system via water passage 9. The water travels through water filter 96 and extended contact chamber 90 into gas/liquid separator 91. Extended contact chamber 90 is configured to provide a residence time which is sufficient to obtain a pre-determined level of treatment prior to the water entering gas/liquid separator 91

Reservoir 89 is provided with a pressure sensor 95 which sends a signal to micro-controller 21 via wire 96. Reservoir 89 is also provided with water outlet 94 which is connected to provide water to the domestic water supply in a house, e.g. the main trunk line which feeds a house or the water supply to a sink, (if the water treatment apparatus is an under counter unit). When reservoir 89 empties, the pressure in reservoir 95 drops signaling micro controller 89 that additional water is required to fill reservoir 89. Micro controller 21 sends a signal to valve 59 to connect extended contact chamber 90 in flow communication with passage way 92 (if the continuous water loop contains treated water).

Accordingly, it will be appreciated that the water treatment apparatus may be used in a domestic (i.e. residential) environment, such as a house, cottage, a mobile home or the like and may be used to treat water from a re-usable water supply which is fed to a house through a municipal supply pipe. It may also be used to treat water which is obtained from a well obtained by an individual or any other source that an individual has for their house, cottage, mobile home or the like.

It can be appreciated that variations to this invention would be readily apparent to those skilled in the art, and this invention is intended to include those alternatives.

1) A water treatment apparatus comprising:
a) a water treatment reactor which contains a volume of water to be treated, the water treatment reactor comprises a water conduit having an inlet end and an outlet end and the inlet and outlet ends are in flow communication during a water treatment cycle so as to define a water flow path;
b) a treatment filter positioned in the water flow path;
c) a pump positioned to cause the water to flow through the water flow path during the treatment cycle; and, d) an ozone source in flow communication with at least one of the water flow path whereby ozone is introduced into the apparatus during a treatment cycle.

2) The apparatus as claimed in claim 1 wherein the volume of water is passed through treatment filter from one to ten times during a treatment cycle.

3) The apparatus as claimed in claim 1 wherein the volume of water is passed through treatment filter from two to eight times during a treatment cycle.

4) The apparatus as claimed in claim 1 wherein the volume of water is passed through treatment filter from four to six times during a treatment cycle.

5) The apparatus as claimed in claim 1 wherein the water flow path comprises the water conduit and a water storage chamber and the inlet end and the outlet end of the water conduit are each in flow communication with the water storage chamber.

6) The apparatus as claimed in claim 5 wherein the ozone source comprises an ozone generator in flow communication with the water storage chamber whereby the water storage chamber also functions as a water treatment chamber.

7) The apparatus as claimed in claim 1 wherein the ozone source comprises an ozone generator in flow communication with the water conduit.

8) The apparatus as claimed in claim 7 wherein the water flow path comprises the water conduit and a water storage chamber and the inlet end and the outlet end of the water conduit are each in flow communication with the water storage chamber and the ozone generator is in flow communication with the water conduit at a position downstream from the treatment filter and upstream from the water storage chamber.

9) The apparatus as claimed in claim 5 wherein the water storage chamber is removably mounted on the apparatus.

10) The apparatus as claimed in claim 1 further comprising a treated water outlet and a gas/liquid separator positioned upstream from treated water outlet.

11) The apparatus as claimed in claim 1 further comprising a pretreatment filter and an off gas collector in communication with water being treated, the off gas including ozone, and a conduit connecting the off gas collector and the pretreatment filter in flow communication during at least a portion of the treatment cycle.

12) The apparatus as claimed in claim 1 further comprising a pressure actuated valve positioned for selectively connecting a dispense conduit in flow communication with the water conduit and a flow prevention valve positioned downstream from the dispense conduit.

13) The apparatus as claimed in claim 5 wherein the water storage chamber has a water inlet port and an associated water inlet valve and the apparatus includes a sensor for monitoring the water level and for closing the water inlet valve when the water storage container contains sufficient water for the treatment cycle.

14) The apparatus as claimed in claim 13 wherein the sensor comprises a float switch.

15) The apparatus as claimed in claim 13 wherein the sensor also monitors the water level when water is removed from the water storage chamber and opens the water inlet valve to allow the water storage chamber to be refilled.

16) The apparatus as claimed in claim 15 wherein the sensor comprises two float switches.

17) The apparatus as claimed in claim 1 wherein the treatment filter has a pore size from 0.5 to 30 microns.

18) The apparatus as claimed in claim 1 wherein the treatment filter has a pore size from 1 to 10 microns.

19) The apparatus as claimed in claim 1 further comprising a treated water passage and a routing valve for selectively directing water to at least one of the water conduit and the treated water passage.

20) The apparatus as claimed in claim 19 wherein during a dispense mode, the pump is energized and the routing valve connects the water conduit and the treated water passage whereby the pump is used to dispense treated water.

21) The apparatus as claimed in claim 1 wherein the inlet and outlet end of the water conduit are in direct flow communication to define a continuous flow reactor.

22) The apparatus as claimed in claim 21 wherein water treatment conduit has a residence time of 30 to 120 seconds.

23) The apparatus as claimed in claim 1 further comprising a water inlet which is positioned upstream of the treatment filter.

24) The apparatus as claimed in claim 23 wherein the water inlet which is positioned downstream from the ozone source such that water to be treated is filtered prior to ozonation.

25) The apparatus as claimed in claim 9 wherein the water storage chamber further comprises a water inlet and a mechanical valve for automatically closing the water inlet during the treatment cycle.

26) The apparatus as claimed in claim 9 wherein the water storage chamber further comprises a water outlet and a mechanical valve for automatically closing the water outlet during the treatment cycle and automatically opening the water outlet when water is poured out of the water outlet of the storage chamber.

27) The apparatus as claimed in claim 9 wherein the apparatus comprises a counter top water treatment apparatus.

28) The apparatus as claimed in claim 1 wherein the apparatus comprises a household water treatment apparatus and the water treatment reactor is in flow communication with a pressurized source of water which is provided to a home, the apparatus includes a reservoir which is selectively connectable to the water treatment reactor and a water supply conduit to the home, the water reservoir includes a sensor which sends a signal to a controller when additional treated water is required in the reservoir.

29) The apparatus as claimed in claim 28 wherein the sensor comprises a pressure sensor.
